(19) United States
(12) Patent Application Publication
(10) Pub. No.: US 2025/0147836 A1
(43) Pub. Date: May 8, 2025

(54) UNPOWERED AUTOMATION DEVICE TROUBLESHOOTING USING NEAR FIELD COMMUNICATION

(71) Applicant: Rockwell Automation Technologies, Inc., Mayfield Heights, OH (US)

(72) Inventors: David C. Mazur, Grafton, WI (US); Kurt D. Sneen, Park City, UT (US)

(21) Appl. No.: 18/899,922

(22) Filed: Sep. 27, 2024

Related U.S. Application Data
(60) Provisional application No. 63/596,441, filed on Nov. 6, 2023.

(51) Int. Cl. G06F 11/07

(52) U.S. Cl. CPC G06F 11/079; G06F 11/0709

(57) ABSTRACT

The disclosure describes an industrial automation environment including an industrial device in communication with a Near Field Communication (NFC) chip. The automation device identifies a fault condition and loads a fault code associated with the fault in the NFC chip. When the device is powered off, a mobile device retrieves the fault code from the NFC chip to facilitate device-troubleshooting. In some implementations, the mobile device loads configuration parameters into the NFC chip when the automation device is powered off. Upon startup, the automation device retrieves the configuration parameters and configures itself accordingly.

### CROSS REFERENCE TO RELATED APPLICATIONS

This application claims priority to U.S. Provisional Patent Application No. 63/596,441,titled “UNPOWERED DEVICE COMMISSIONING AND TROUBLESHOOTING IN AN INDUSTRIAL AUTOMATION SYSTEM,” filed Nov. 6, 2023, the contents of which is incorporated by reference in its entirety for all purposes.

### BACKGROUND

In industrial settings, technicians regularly interact with automation devices to perform a range of maintenance and configuration tasks. For instance, technicians may frequently access memory of automation devices to retrieve information such as fault codes identifying fault conditions. Technicians may utilize this information to diagnose issues and implement corrective measures. In other scenarios, technicians interact with automation devices to perform configuration tasks. For example, when bringing a new automation device online or updating an existing one, a technician configures various operating parameters such as torque limits, speed settings, and other operational thresholds.

To perform maintenance on automation devices (e.g., drives or other components in a panel) in an industrial automation environment, maintenance technicians follow basic electrical safety procedures to access the equipment. In existing systems, the equipment usually needs to be energized to provide a technician with information about the state and identity of the devices. Procedures followed to safely access energized devices may include, for example, using personal protective equipment (PPE), employing specialized equipment such as insulated tools, and adhering to government regulations to prevent electrical hazards. Furthermore, technicians often require specialized training to ensure they are knowledgeable about the standards and protocols for safely working with energized equipment. The need for specialized training and equipment, along with the implementation of stringent safety procedures, can lead to increased costs and operational delays. Furthermore, in existing systems, there is no access to data within the devices when they are in the powered-off state.

### SUMMARY

The technology described herein includes an industrial automation environment in which a user on a mobile device may interface with an automation device via a Near Field Communication (NFC) chip. In one scenario, the mobile device retrieves information (e.g., fault codes) from the NFC chip that the automation device loads into the NFC chip during runtime. In another scenario, the mobile device loads configuration selections into the NFC chip that the automation device subsequently retrieves and uses to configure parameters of the automation device. During transfer of data between the mobile device and the NFC chip, the automation device may be in a powered-off state, thus alleviating the above-described issues.

One example of a computer-implemented method performed according to some embodiments includes identifying, by an automation device, an occurrence of a fault condition in the automation device. The method further includes loading, by the automation device, a fault code associated with the fault condition into non-volatile memory of a near field communication (NFC) chip. The method further includes obtaining, at the software application, the fault code from the NFC chip when the automation device is in a powered-off state. The fault code is obtained wirelessly via an NFC link.

In some implementations, the method further includes receiving, at the software application of the mobile device, a request to view documentation associated with the fault code. The method may further include retrieving, by the software application of the mobile device, the documentation from a data repository. The method may further include displaying, at the software application of the mobile device, the documentation in a user interface of the mobile device.

In some implementations, the method further includes generating, at the software application of the mobile device, a prompt for an artificial intelligence model trained to provide recommendations for device troubleshooting. The prompt includes a request for a recommendation for addressing the fault condition.

In some implementations, the method further includes receiving, at the software application of the mobile device, the recommendation from the artificial intelligence model. The method may further include displaying, at the software application of the mobile device, the recommendation in a user interface of the mobile device.

In some implementations, the method further includes loading, by an automation device, an identification of the automation device and an Internet Protocol (IP) address of the automation device into the non-volatile memory of the NFC chip. The method may further include obtaining the identification and the IP address concurrently with obtaining the fault code.

In some implementations, the method further includes receiving, at the software application, one or more configuration selections from the user via a user interface of the mobile device. The method may further include loading, at the software application, the configuration selections to the NFC chip via the NFC link. Loading the selections is performed when the automation device is in the powered-off state. The method may further include retrieving, by the automation device, the configuration selections from the NFC chip during startup of the automation device. The method may further include configuring, by the automation device, the automation device according to the configuration selections.

In some implementations, the configuration selections include one or more of: an IP address selection, a device identification selection, and one or more operating parameter selections.

In some implementations, NFC chip is incorporated in the automation device.

In some implementations, the automation device is one of a plurality of automation devices in a panel. The NFC chip is in communication with each of the plurality of automation devices to receive fault codes from each of the plurality of automation devices.

These and other features and aspects of various examples may be understood in view of the following detailed discussion and accompanying drawings.

### BRIEF DESCRIPTION OF THE DRAWINGS

FIG. 1A illustrates an industrial automation environment in an implementation.

FIG. 1B illustrates an industrial automation environment in another implementation.

FIG. 2 illustrates a device troubleshooting process in an implementation.

FIG. 3 illustrates an operational sequence in an implementation.

FIGS. 4A-4C illustrate user interfaces in an implementation.

FIG. 5 illustrates a device configuration process in an implementation.

FIG. 6 illustrates another operational sequence in an implementation.

FIGS. 7A-7B illustrate additional user interfaces in an implementation.

FIG. 8 illustrates an automation device in an implementation.

FIG. 9 illustrates a computing system suitable for implementing various operational environments, architectures, environments, processes, scenarios, sequences, and frameworks discussed below with respect to the other Figures.

### DETAILED DESCRIPTION

Regular maintenance is performed on automation devices (e.g., variable frequency drives, direct-on-line controllers, and programmable logic controllers among others) to ensure proper functioning. This maintenance encompasses troubleshooting actions to address fault conditions and configuration tasks to set various operational parameters. In existing systems, this maintenance is often performed while the automation devices are energized, since internal parameters may be inaccessible when the devices are powered off. To mitigate the electrical hazards inherent in these operations, technicians follow various safety procedures. These procedures include the use of personal protective equipment (PPE), specialized safety equipment, and adherence to safety protocols, which may be mandated by government regulations or company policy.

The performance of maintenance on energized automation devices introduces several inefficiencies. Adhering to stringent safety protocols, including the use of PPE and specialized equipment, increases the complexity and duration of maintenance tasks. Specialized training requirements and operational delays due to downtime also contribute to reduced productivity and increased costs.

The present disclosure describes an industrial automation environment that employs a Near Field Communication (NFC) chip in communication with an automation device to enable a technician to perform maintenance tasks when the automation device is powered-off. Using a mobile device, the technician may send data and receive data with the NFC chip while the automation device is in a powered-off state. When the automation device is powered on, the automation device communicates directly with the NFC chip.

In one scenario, the automation device may identify an occurrence of a fault condition during runtime. For example, when the automation device is a variable frequency drive, fault conditions may include overspeed (where a motor's speed exceeds operating limits), load loss (where measured torque is below a threshold value for a set amount of time), overvoltage (where bus voltage exceeds a maximum limit), among others. Upon identifying the fault condition, the automation device loads a fault code associated with the fault condition into the NFC chip.

At some point after the automation device loads the fault code, the automation device may be powered-off. For instance, a technician may cut power to the device to perform maintenance functions. The technician may then retrieve the fault code from the NFC chip with the mobile device. Specifically, the mobile device obtains the fault code from the NFC chip wirelessly via an NFC link when the mobile device is placed in proximity to the NFC chip.

Once the mobile device obtains the fault code, the technician may perform various troubleshooting actions to address the associated fault condition. The mobile device may facilitate this process by retrieving documentation associated with the fault condition for display and initiating a chat with an artificial intelligence model trained to provide device- troubleshooting assistance, according to some implementations.

In another scenario, the technician may utilize the NFC chip to configure the automation device. The technician may use the mobile device's user interface to input configuration selections. These configuration selections may include selections of various operating parameters (e.g., torque limits and speed settings), addressing information, and device identifications. The technician loads the configuration parameters into the NFC chip via the NFC link, by placing the mobile device in proximity to the NFC chip while the automation device is in the powered-off state. When the automation device is subsequently powered on, the automation device obtains the configuration parameters from the NFC chip and updates its configuration accordingly. This arrangement allows a technician to configure the automation device when the automation device is in a powered-off state. Furthermore, the technician may load the configuration selections before the automation devices are even installed (e.g., upon arrival from the manufacturer).

The industrial automation environment described herein thus facilitates troubleshooting and configuring automation devices when the devices are powered off, thus providing for commission-less powering on of automation devices. This arrangement reduces the electrical hazards associated with maintenance tasks, increasing safety and resulting in cost savings due to the reduced need for specialized equipment and procedures. Additionally, reduced downtime may be achieved through these streamlined procedures. Finally, energy savings are achieved, since the automation devices do not need to be energized during the maintenance procedures.

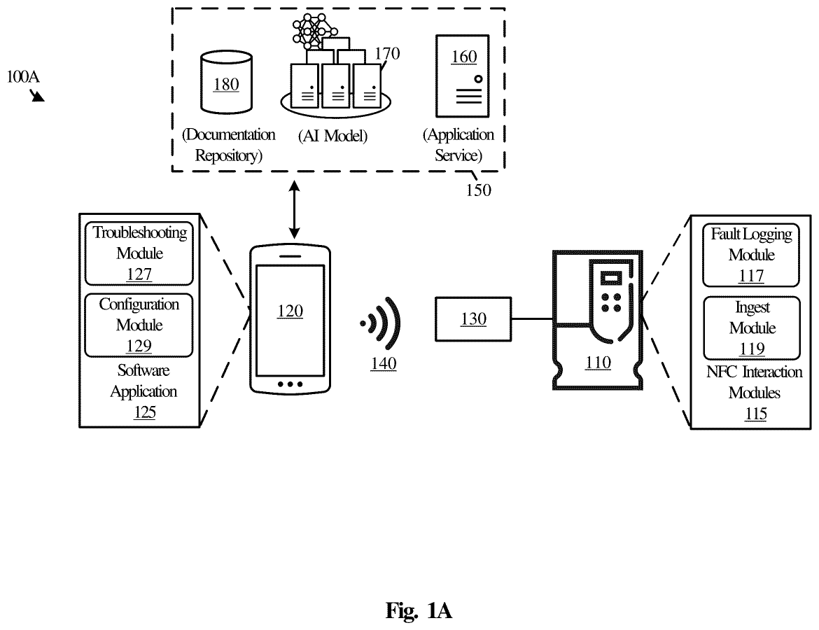

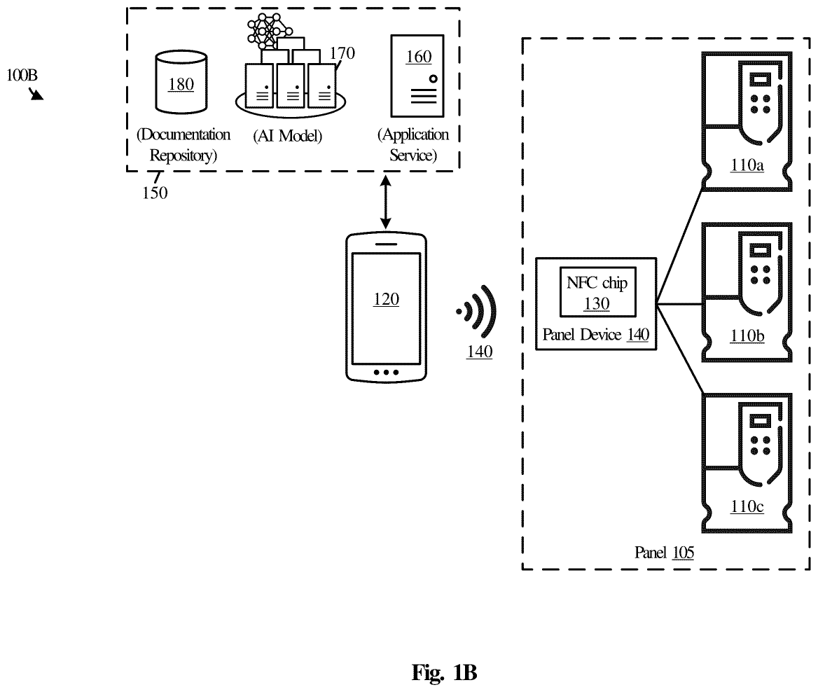

FIG. 1A illustrates industrial automation environment 100A in an implementation. Industrial automation environment 100A includes automation device 110, NFC chip 130, mobile device 120, and cloud platform 150. Automation device 110 is in communication with NFC chip 130. In some implementations, NFC chip 130 may be integrated in the automation device 110 (e.g., on the casing of automation device 110 or in a human interface module (HIM) of automation device 110). In other implementations, NFC chip 130 may not be integrated in automation device 110 (as shown for example in FIG. 1B). Automation device 110 loads and retrieves data from NFC chip 130 via a wired connection, according to some implementations. Mobile device 120 communicates with NFC chip 130 via NFC link 140, as explained further below. Mobile device 120 is in communication with cloud platform 150 (e.g., via a wireless network, according to some implementations.)

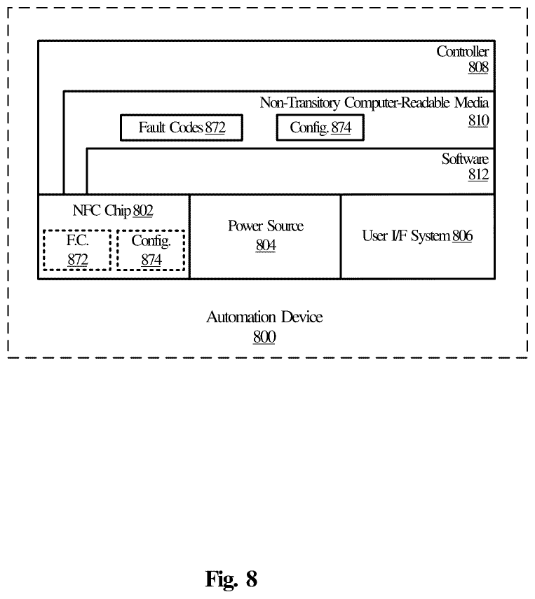

Automation device 110 represents a device that performs an industrial automation function in industrial automation environment 100A. Automation device 110 may be, for example, a variable frequency drive, a direct-on-line controller, and a programmable logic controller, among other types of intelligent devices and motor drives. Automation device 110 may be automation device 800 as described in FIG. 8.

Automation device 110 includes NFC interaction modules 115. NFC interaction modules 115 include fault logging module 117 and ingest module 119. NFC interaction modules 115 are representative of functions performed by automation device 110 for interacting with NFC chip 130. NFC interaction modules 115 (including fault logging module 117 and ingest module 119) may be implanted in software, firmware, or hardware elements of automation device 110. For example, in one implementation, NFC interaction modules 115 include program instructions stored in a memory device (e.g. non-transitory computer-readable media 810 of FIG. 8) and executed by a controller (e.g. controller 808 of FIG. 8) of automation device 110.

Fault logging module 117 is a module configured to identify fault conditions in automation device 110 and load fault codes into NFC chip 130. Various fault conditions may occur during runtime of automation device 110 including overspeed, overvoltage, and load loss, among others. Fault logging module 117 monitors operational data (including sensor data and event logs) to identify that one of the various fault conditions has occurred. For example, fault logging module 117 may monitor tachometer data to determine if motor speed has exceeded a preset threshold limit. In this example, fault logging module 117 would identify the overspeed fault condition when it determines that the motor speed exceeds the threshold.

Once fault logging module 117 identifies the fault condition, fault logging module 117 loads a fault code associated with the fault condition in NFC chip 130. Specifically, the fault code may be transferred from an active register of automation device 110 (which may be located in memory of automation device 110) to a persisted register in the non-volatile memory of NFC chip 130. Fault logging module 117 may maintain a table of fault conditions in association with their respective fault codes. These fault codes may be a number or an alpha-numeric string. By way of example, a fault code associated with the overspeed fault condition may be “25.” Accordingly, the fault codes indicate a health state of automation device 110. If no fault codes are identified, fault logging module 117 may load a health state indicating that automation device 110 is healthy. In some implementations, fault logging module 117 may load additional information into NFC chip in association with the fault codes. For example, fault logging module 117 may load a device identification of automation device 110 (such as a device identity, a serial number, or both) into NFC chip 130 in association with the fault code. Additionally, fault logging module 117 may load an IP address for automation device 110 into NFC chip 130 in association with the fault codes. The device identification and IP address provide users with information correlating the fault conditions with the devices in which they occurred, as well as the addressing information which may be used to configure the appropriate device. The data loaded into NFC chip 130 may be later retrieved by mobile device 120 when automation device 110 is in a powered-off state, as explained further below. The fault codes may be represented by fault codes 872 of FIG. 8.

Ingest module 119 is configured to ingest configuration selections from NFC chip 130. Ingest module 127 may retrieve the configuration selections from NFC chip 130 as part of the startup procedures of automation device 110. Specifically, the configuration selections may be transferred from the persisted register in the non-volatile memory of NFC chip 130 to the active register of automation device 110 (which may be located in memory of automation device 110). Configuration selections are loaded into NFC chip 130 by mobile device 120 when automation device 110 is in the powered-off state, as explained further below. Configuration selections may include one or more an IP address selection (e.g., where a user desires to update the IP address of automation device 110), a device identification selection such as a device name (e.g., “PowerFlex A”) and one or more one or more operating parameter selections (e.g., basic startup configuration settings, torque limit settings, speed settings, and the like). The configuration selections may be represented by configuration 874 of FIG. 8.

Once ingest module 119 ingests the configuration selections from NFC chip 130, automation device 110 updates its configuration accordingly. Specifically, automation device 110 updates the parameters (including the selected IP address, device name, and/or operating selections) in its configuration settings which may be implemented in software of automation device 110, such as software 812 in FIG. 8.

NFC chip 130 is a compact, low power device configured to send and receive data with automation device 110 and mobile device 120. NFC chip includes non-volatile memory configured to store data (e.g., fault codes received from automation device 110 and configuration selections received from mobile device 120). NFC chip 130 communicates both with automation device 110 (when automation device 110 is in the powered-on state) and mobile device 120 (when automation device 110 is in the powered-off state). NFC chip 130 may be incorporated in automation device 110 in some implementations. For example, NFC chip 130 may be disposed on the housing of automation device 110 or in a HIM of automation device 110 in various implementations. In other implementations (as shown for example in FIG. 1B), NFC chip 130 may be disposed in another location, such as on a panel.

NFC chip 130 communicates with automation device 110 via a wired connection. Specifically, a controller (such as controller 808 of FIG. 8) of automation device 110 is configured to load fault codes into NFC chip 130 and retrieve configuration selections from NFC chip 130 via the wired connection, as explained further below.

NFC chip 130 communicates with mobile device 120 via NFC link 140. When mobile device 120 is brought into proximity with NFC chip 130, it generates an electromagnetic field. This field is captured by the integrated antenna of NFC chip 130, which then harvests the energy from the field to power its operations. Once powered, the NFC chip engages in signal processing to decode modulated signals (represented by NFC link 140) containing incoming data (i.e., configuration selections) from mobile device 120 and stores this data in its non-volatile memory (i.e., in a persisted register of NFC chip 130). Conversely, when mobile device 120 retrieves data (i.e., fault codes) from NFC chip 130, NFC chip 130 reads the stored data from its non-volatile memory, processes it, and transmits it to mobile device 120 through modulated signals of NFC link 140.

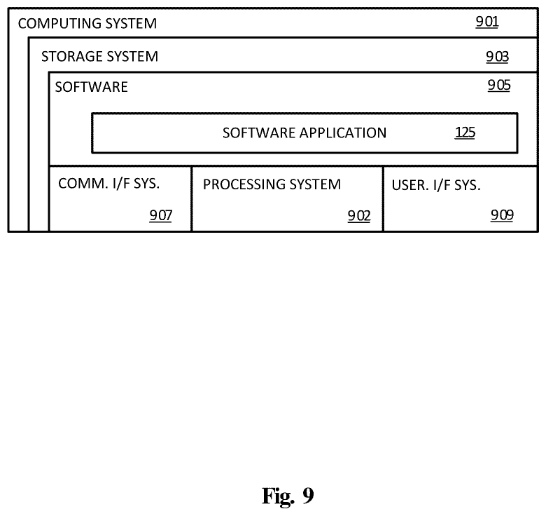

Mobile device 120 is a device utilized by a user for device troubleshooting and configuration. Mobile device 120 may be a portable device such as a cell phone, a tablet, a laptop, a Human Interface Module (HIM) and the like. Mobile device 120 may be computing system 901 of FIG. 9. Mobile device 120 includes NFC communication hardware enabling mobile device to send and receive data with NFC chip 130 via NFC link 140 when mobile device 120 is in proximity to NFC chip 130.

Mobile device 120 executes software application 125, which is representative of an application used for device maintenance. Software application 125 may be stored in memory of mobile device (represented for example by storage system 903 of FIG. 9) and executed by one or more processors (represented for example by processing system 902 of FIG. 9) of mobile device 120. Software application 125 provides a user interface in the display of mobile devices, to provide users with device information and receive configuration selections. Software application 125 includes troubleshooting module 127 and configuration module 129, which are representative of elements of software application 125 performing the functions explained below.

Troubleshooting module 127 performs device-troubleshooting functions. Specifically, troubleshooting module 127 obtains device information from NFC chip 130, including fault codes, device identifications, and the IP address (which are loaded into NFC chip 130 by automation device 110 as described above). Mobile device 120 obtains the fault codes from NFC chip 130 via NFC link 140 when automation device 110 is in the powered-off state.

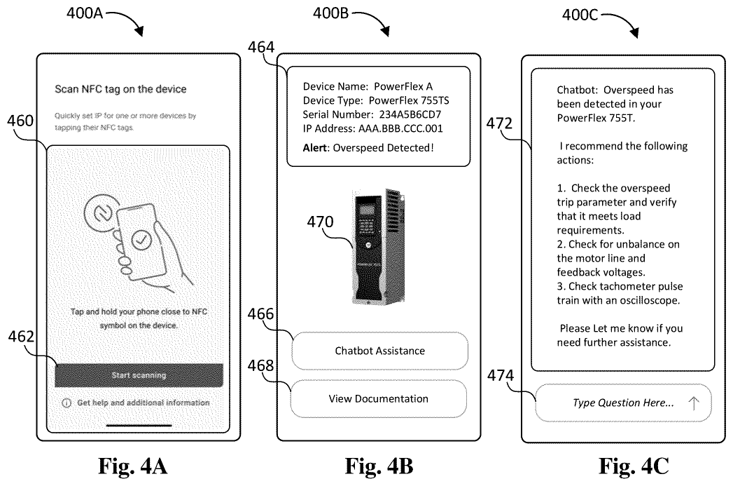

Once troubleshooting module 127 obtains the device information, it displays the information in a user interface of mobile device 120, such as user interface 400B in FIG. 4B. When troubleshooting module 127 obtains one or more fault codes, it displays an alert identifying the fault condition associated with the fault code in the user interface (as demonstrated in element 464 of FIG. 400B). Troubleshooting module 127 may include a table correlating the fault codes with the associated fault conditions (e.g., “Overspeed” may be associated with fault code “25” in one example). Alternatively, troubleshooting module 127 obtains the relevant fault conditions for the fault codes from documentation repository 180 of cloud platform 150. In either case, the fault conditions are retrieved and displayed to the user, as demonstrated in FIG. 4B.

Troubleshooting module 127 interfaces with cloud platform 150 to provide troubleshooting assistance. For example, a user may request to view documentation associated with fault conditions (e.g., by selecting the “view documentation” element 468 of FIG. 4B). In response, troubleshooting may request and obtain documentation from documentation repository 180, including for example, device manuals, device specifications, device maintenance documents, and other documents relevant to addressing fault conditions. Troubleshooting module 127 provides the obtained documentation for display on mobile device 120.

Additionally, a user may request artificial intelligence (AI) assistance (e.g., by selecting “Chatbot Assistance” element 466 of FIG. 4B). In response, troubleshooting module 127 generates a prompt for an AI model 170. As described further below, AI model 170 is trained to provide recommendations for device troubleshooting. The prompt includes a request for a recommendation for addressing the fault condition. As an example, where overspeed is detected, an exemplary prompt might read “Overspeed has been detected in a PowerFlex 755TS. Provide troubleshooting recommendations for addressing this issue.” In response, AI model 170 returns a recommendation to mobile device 120. Troubleshooting module 127 displays the recommendation in a user interface, as demonstrated for example in user interface 400C of FIG. 4C.

Cloud platform 150 includes application service 160, AI model 170, and documentation repository 180. Cloud platform 150 operates from servers which may be located in data centers, distributed in various geographic locations, and the like. Various software components of cloud platform 150 may have multiple instances in different geographic locations.

Application service 160 is a service implemented in cloud platform 150 that provides back-end services for software application 125. Mobile device 120 downloads software application 125 from the application service 160. Application service 160 manages requests from mobile device 120, including receiving AI prompts and forwarding them to AI model 170, as well as receiving documentation requests and retrieving relevant documentation from documentation repository 180. Additionally, application service 160 forwards responses from AI model 170 and retrieves documentation from documentation repository 180 to mobile device 120.

AI model 170 is an artificial intelligence model trained to provide recommendations for device troubleshooting. In some embodiments, AI model 170 may be a generative artificial intelligence model, such as a large language model trained on a vast amount of textual data and may be fine-tuned to provide assistance for tasks in industrial automation environment 100A. AI model 170 may be trained on documentation to enable it to provide device troubleshooting recommendations. Documentation used to train AI model 170 may include for example, industrial automation workflows, device manuals, device specifications, device maintenance documents, and other documents relevant to addressing fault conditions (e.g., from documentation repository 180). AI model 170 receives, from mobile device 120 (via application service 160), prompts requesting recommendations for addressing fault conditions. AI model 170 generates and provides the recommendations to mobile device 120 (via application service 160).

Generative artificial intelligence (GAI) models (also sometimes known as foundation models) are models trained to generate new data based on a training dataset. GAI models as used herein include large-scale generative artificial intelligence (AI) models trained on massive quantities of diverse, unlabeled data. The GAI models learn using self-supervised, semi-supervised, or unsupervised techniques. GAI models perform many downstream tasks based on capturing general knowledge, semantic representations, and patterns and regularities in the training data. In some embodiments, such as embodiments included herein, a GAI model may be fine-tuned for specific downstream tasks. GAI models include BERT (Bidirectional Encoder Representations from Transformers) and ResNet (Residual Neural Network). GAI models may be based on any relevant architecture, including, for example, generative adversarial networks (GANs), variational auto-encoders (VAEs), and transformer models, including multimodal transformer models. Depending on the type of input accepted and output provided, GAI models may be multimodal or unimodal.

Multimodal models are a class of GAI model that accepts multimodal data including text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of a given image by extracting visual features using an image encoder, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video-generating a text description of the video or generating video based on a text description.

Multimodal models include visual-language foundation models, such as CLIP (Contrastive Language-Image Pre-training), ALIGN (A Large-scale ImaGe and Noisy-text embedding), and VILBERT (Visual-and-Language BERT), for computer vision tasks. Examples of visual multimodal or foundation models include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a type of GAI model that process and generate natural language text. These models are trained on massive amounts of textual data. LLMs learn to generate relevant responses given a prompt or input text. The responses are coherent and contextually relevant to the given prompt. LLMs understand and generate sophisticated language based on their training. LLMs capture intricate patterns, semantics, and contextual dependencies in textual data. In some cases, LLMs may be used in multimodel models. For example, the LLM intelligence is used to combine images and audio input with textual input to generate multimodal output. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge IntEgration) models, T5 (Text-to-Text Transfer Transformer), and XLNet models are types of transformer models which have been pretrained on large amounts of text data using a self-supervised learning technique called masked language modeling. For example, large language models, such as ChatGPT and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses that are creative, open-ended, and unpredictable.

Documentation repository 180 is representative of a data repository in cloud platform 150. Documentation repository 180 contains a collection of documents relevant to device troubleshooting, including device manuals, device specifications, maintenance documents, and other documentation. When mobile device 120 sends a request to view documentation, application service 160 retrieves the relevant documents from the documentation repository 180 and forwards them to mobile device 120.

FIG. 1B illustrates industrial automation environment 100B in another implementation. Industrial automation environment 100B includes panel 105, mobile device 120, and cloud platform 150. Various elements of industrial automation environment 100B are similar to corresponding elements described above with respect to industrial automation environment 100B. Industrial automation environment 100B illustrates an implementation where NFC chip 130 is disposed in panel device 145 that manages data interactions for multiple automation devices 110a, 110b, 110c.

Panel 105 is representative of an industrial unit (e.g., one or more cabinets) including an array of devices. Panel 105 includes automation devices 110a, 110b, 110c, and panel device 145. While three automation devices 110a, 110b, 110c are shown for simplicity, any number of automation devices 110a, 110b, 110c may be included in panel 105.

Automation devices 110a, 110b, 110c, may be substantially similar to automation device 110 of FIG. 1A. Specifically, automation devices 110a, 110b, 110c, include NFC interaction modules 115 as illustrated in FIG. 1A (not shown in FIG. 1B for clarity). In FIG. 1B, automation devices 110a, 110b, 110c interact with NFC chip 130 in a similar manner discussed with respect to FIG. 1A above; however, FIG. 1B illustrates that this interaction may be via panel device 145.

Panel device 145 is representative of a device providing a data interface for multiple industrial units (i.e., automation devices 110a, 110b, 110c). Specifically, panel device 145 is configured to receive data (e.g., fault codes) from each automation device 110a, 110b, 110c, and load the data into NFC chip 130, which may be in panel device 145. Further, panel device 145 is configured to retrieve data from NFC chip 130 (e.g., configuration selections loaded from mobile device 120) and provide the data to automation devices 110a, 110b, 110c, as discussed further below. Panel device 145 may be represented by automation device 800 of FIG. 8.

Each automation device 110a, 110b, 110c monitors for fault conditions, and when fault conditions are identified, provide fault codes (along with an IP address and a device identification in some implementations) to panel device 145. Panel device 145 receives this data from automation devices 110a, 110b, 110c, and loads the data received into NFC chip 130. Thus, fault information from multiple automation devices 110a, 110b, 110c, is loaded into the same NFC chip 130. A user on mobile device 120 may obtain fault information for all devices in panel 105 by making one scan (in NFC chip 130). This scan may be performed when automation devices 110a, 110b, 110c are in the powered-off state. For example, a user may cut power to the entire panel 105 before scanning NFC chip 130 in panel device 145.

Mobile device 120 is described in FIG. 1A above. Mobile device 120 includes software application 125 of FIG. 1A (not shown in FIG. 1B for clarity). Mobile device 120 may load configuration selections for one or more of automation devices 110a, 110b, 110c, into NFC chip 130 via NFC link 140. The configuration selections may be substantially similar to those described in the discussion of FIG. 1A above. The configuration selections may be stored in association with a device identification (e.g., a serial number or device name) so that the configurations may be applied to the intended devices. Upon startup of automation devices 110a, 110b, 110c, e.g., when a user applies power to panel 105, panel device 145 provides the configuration selections to automation devices 110a, 110b, 110c. Automation devices 110a, 110b, 110c receive the configuration selections and apply the configurations intended for each respective device.

Cloud platform 150 includes documentation repository 180, AI model 170, and application service 160. Cloud platform 150 and its constituent elements are described above in the discussion of FIG. 1A.

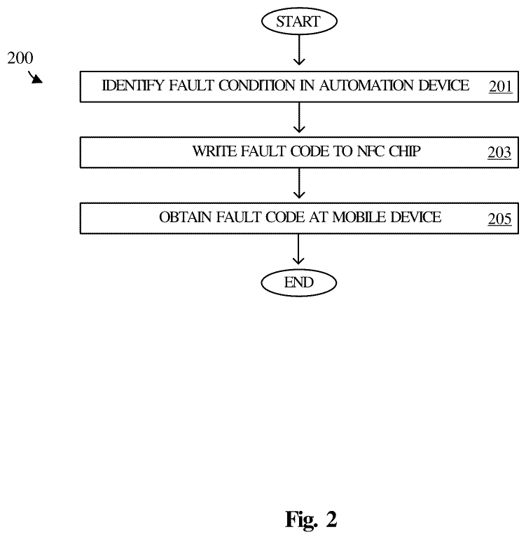

FIG. 2 illustrates a device-troubleshooting process represented by process 200. Process 200 is employed by automation device 110 and mobile device 120.

Step 201 of process 200 is identifying a fault condition in automation device 110. Step 201 is performed by automation device 110, and more specifically by fault logging module 117. Automation device 110 monitors operational data (including, e.g., sensor data and fault logs) and identifies a fault condition based on the operational data. For example, automation device 110 may monitor the temperature of output transistors using sensor data. A fault condition is identified where the temperature exceeds a preset operating temperature. It is noted that in some cases, multiple fault conditions may be identified in step 201, as automation device 110 may be configured to monitor a wide range of conditions (e.g., speed, torque, temperature, shaft alignment, etc.) during runtime.

Step 203 of process 200 is loading a fault code associated with the fault condition into NFC chip 130. Step 203 is performed by automation device 110, and more specifically by fault logging module 117. As discussed above, automation device 110 may maintain a table correlating fault conditions to fault codes. Once automation device 110 identifies the fault condition (in step 201), automation device 110 loads the relevant fault code into NFC chip 130. Where multiple fault conditions are identified in step 201, automation device 110 loads the fault code for each of the identified conditions into NFC chip 130. In some implementations, automation device 110 additionally loads the device identification and IP address for the device in NFC chip 130 in association with the fault code. The fault code, device identification, and IP address are loaded into the non-volatile memory of NFC chip 130.

Step 205 is obtaining the fault code at mobile device 120. Step 205 is performed by mobile device 120, and more specifically by troubleshooting module 127. Step 205 is performed when automation device 110 is in a powered-off state. Specifically, at some time after step 203, a user may cut power to automation device 110 to perform maintenance operations, for example. A user may then scan NFC chip 130 with mobile device 120 (as demonstrated, for example in user interface 400A of FIG. 4A) with mobile device 120 placed in proximity to NFC chip 130. During the scanning process, mobile device 120 obtains, via NFC link 140, the fault codes, device identification, and IP address, that were loaded into NFC chip 130 at step 203.

During step 205, NFC chip 130 establishes NFC link 140 with mobile device 120. To establish NFC link 140, NFC chip 130 harvests power from the electrical field generated by mobile device 120 when mobile device 120 is brought in proximity to NFC chip 130. NFC chip 130 uses the harvested power to retrieve the fault codes from its non-volatile memory and transmit them to mobile device 120 through modulated signals of NFC link 140.

Once the fault code is obtained, mobile device 120 displays an alert identifying the fault condition (as demonstrated in user interface 400B of FIG. 4B). A user may then request to view documentation or request chatbot assistance (as further demonstrated in user interface 400B of FIG. 4B). Accordingly, by scanning NFC chip 130 with mobile device 120, a user may obtain fault information and initiate a troubleshooting process while automation device 110 is in a powered-off state. This reduces the need for users to have specialized safety equipment and safety training to initiate troubleshooting.

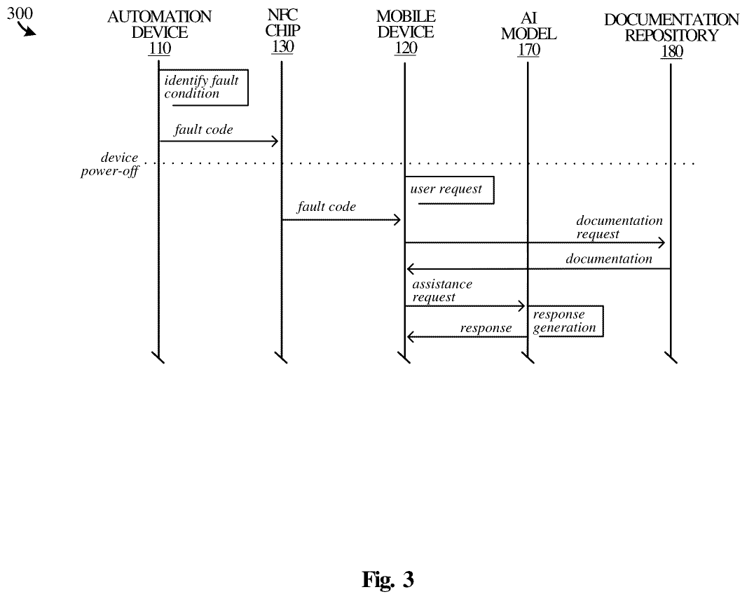

FIG. 3 illustrates an operational sequence of an application of process 200 in the context of industrial automation environment 100A or 100B in an implementation, represented by sequence 300. Sequence 300 includes automation device 110, NFC chip 130, mobile device 120, AI model 170, and documentation repository 180.

At the start of sequence 300, automation device 110 is in a powered-on state performing industrial processes. Automation device 110 continuously monitors for fault conditions (e.g., overspeed and overtemperature) during operation. Automation device 110 identifies a fault condition (as discussed above in the with respect to step 201 of process 200). Upon identifying the fault condition, automation device 110 loads a fault condition associated with the fault condition into NFC chip 130 (as discussed above with respect to step 203 of process 200). At some time after automation device 110 identifies the fault code, automation device 110 may be powered-off. For example, a technician may cut power to automation device 110 to perform maintenance or troubleshooting. Accordingly, the remainer of sequence 300 may occur when automation device 110 is in a powered-off state. The device power-off is represented by the dotted line shown in FIG. 3.

After automation device 110 is powered-off, mobile device 120 receives a user request to perform a scan. For example, a user may select “Start scanning” element 462 in user interface 400A of FIG. 4A to make the request. The user makes the request and holds mobile device 120 in proximity to NFC chip 130 to make the scan. The fault code is then transferred from NFC chip 130 to mobile device 120 via NFC link 140 (as discussed above with respect to step 205 of process 200).

Mobile device 120 submits a request to documentation repository 180 for documentation relevant to the identified fault condition. Mobile device 120 may submit the request in response to a user selection (e.g., a selection of “View Documentation” element 468 in user interface 400B of FIG. 4B). In some implementations, the request for documentation may be submitted to documentation repository 180 via application service 160 of FIGS. 1A and 1B. Documentation repository 180 returns to mobile device 120 (via application service 160), the relevant documentation (including device manuals, fault troubleshooting guides, etc.) for viewing by the user.

Mobile device 120 submits an AI assistance request to AI model 170. Mobile device 120 may submit the assistance request in response to a user selection (e.g., a selection of “Chatbot Assistance” element 466 in user interface 400B of FIG. 4B). The request for assistance may be a prompt identifying the fault condition and requesting troubleshooting recommendations. AI model 170 generates a response (including a troubleshooting recommendation) and returns the response to mobile device 120. Mobile device 120 displays the troubleshooting recommendation, as demonstrated in user interface 400C of FIG. 4C.

FIGS. 4A-4C illustrate user interfaces 400A, 400B, 400C of mobile device 120 according to some implementations. User interfaces 400A, 400B, 400C illustrate a sequence of interfaces displayed in a screen of mobile device 120 for a user performing device-troubleshooting operations. User interfaces 400A, 400B, 400C are exemplary; in other implementations user interfaces on mobile device 120 for device troubleshooting may have additional or fewer elements.

FIG. 4A illustrates user interface 400A, in which a user is prompted to scan NFC chip 130. User interface 400A includes an instruction element 460 which instructs the user to hold mobile device 120 close to NFC chip 130, and “Start scanning” element 462 which a user may tap to begin scanning. During the scan, information (including fault codes) is transferred from NFC chip 130 to mobile device 120 via NFC link 140, as discussed in step 205 of FIG. 2.

FIG. 4B illustrates user interface 400B. User interface 400B includes information element 464 which displays information about automation device 110 including the device name, the device type, the serial number, the IP address and an alert identifying a fault condition based on the fault code. This information may be generated based on the data obtained from NFC chip 130 (which may include device identification, IP address, and a fault code, as discussed above). User interface 400B may further include image 470 of automation device 110 in some implementations (in this case, a PowerFlex 755TS). User interface 400B further includes “Chatbot Assistance” element 466 (which a user may select to request assistance from AI model 170). Upon selection of “Chatbot Assistance,” a prompt is generated for AI model 170 of FIGS. 1A and 1B. The prompt may be generated either by mobile device 120 or application service 160 in various implementations. The prompt may include the device type, the fault condition, and a request to provide a troubleshooting recommendation. In response, AI model 170 generates a recommendation, which application service 160 provides to mobile device 120 for display (as demonstrated further in FIG. 4C).

User interface 400B of FIG. 4C further includes “View Documentation” element 468, which a user may select to view relevant documentation for addressing the fault condition. Upon selection of “View Documentation” element 468, application service 160 retrieves relevant documentation (e.g., device manuals, fault troubleshooting guides, etc.) from documentation repository 180 and provides the documentation to mobile device 120 for display.

FIG. 4C illustrates user interface 400C. User interface 400C includes chatbot assistance element 472, which is generated by AI model 170 in response to a request for chatbot assistance (e.g., in response to selection of Chatbot Assistance element 466 of FIG. 4B). FIG. 4C illustrates several troubleshooting recommendations generated by AI model 170 for addressing overspeed in automation device 110. User interface 400C further includes input element 474, in which a user may type a follow-up question for submission to AI model 170. For example, a user may type in “how do I check for unbalance on the motor line?” or “please provide further troubleshooting recommendations.” When the user submits the follow-up question, a new prompt is generated and submitted to AI model 170, and AI model 170 provides a generated response, which may be displayed in chatbot assistance element 472.

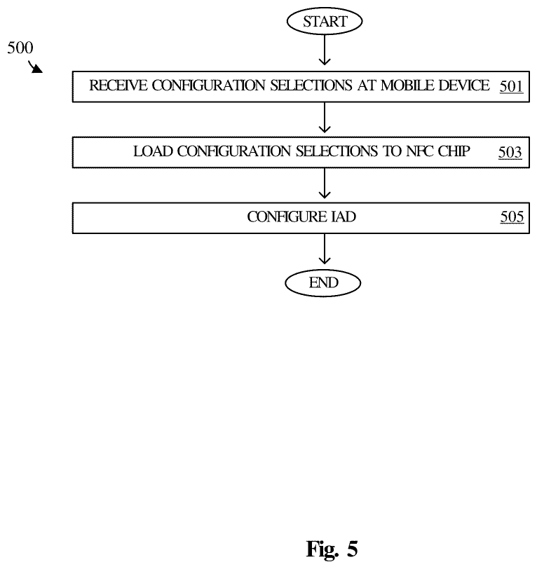

FIG. 5 illustrates a device-troubleshooting process represented by process 500. Process 500 is employed by automation device 110 and mobile device 120.

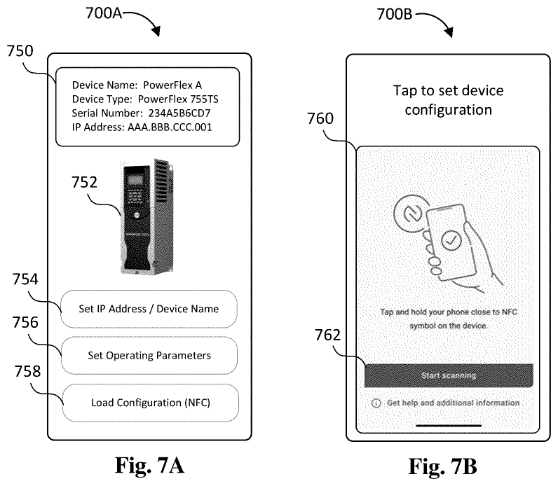

Step 501 is receiving one or more device configuration selections at mobile device 120. Step 201 is performed by mobile device 120, and more specifically by configuration module 129. Device configuration selections may include one or more of a device identification selection (e.g., setting a device name), an IP address selection (in order to set or update the IP address of automation device 110), and one or more operating parameter selections (e.g., torque limits, speed settings, and the like). Receiving the one or more device configuration selections may include receiving a configuration file uploaded by a user (as demonstrated in user interface 700A of FIG. 7A) or receiving configuration selections which a user may input directly into the user interface of mobile device 120.

Step 503 is loading the one or more configuration selections into NFC chip 130. Step 503 is performed by mobile device 120, and more specifically by configuration module 129. At step 503, a user of mobile device 120, may request to transmit the one or more configuration selections to NFC chip 130 so as to configure automation device 110 (e.g., by selecting “Start scanning” element 762 in user interface 700B of FIG. 7B). The user places mobile device 120 in proximity to NFC chip 130 to transmit the configuration selections via NFC link 140. Step 503 may be performed when automation device 110 is in a powered-off state. Indeed, step 503 may even be performed before automation device 110 has even been installed in a panel or cabinet after arrival and unboxing of automation device 110.

Step 505 is configuring automation device 110. Step 505 is performed by automation device 110. Specifically, upon start-up of automation device 110, automation device 110 (and more specifically, ingest module 119) retrieves the configuration selections from NFC chip 130 and updates its configuration according to the configuration selections. Specifically, automation device 110 updates the parameters (including the selected IP address, device name, and/or operating selections) in its configuration settings which may be implemented in software of automation device 110, such as software 812 in FIG. 8.

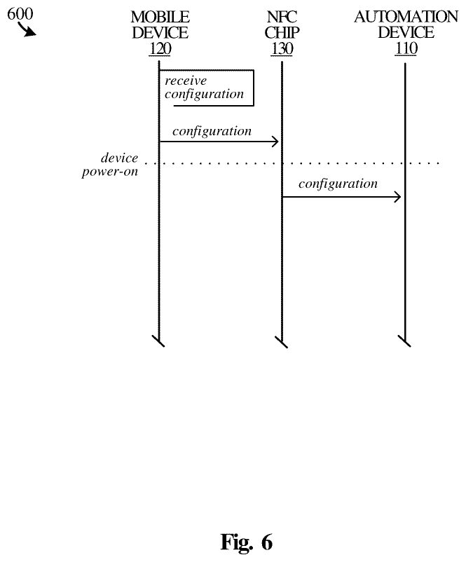

FIG. 6 illustrates an operational sequence of an application of process 200 in the context of industrial automation environment 100A or 100B in an implementation, represented by sequence 600. Sequence 600 includes mobile device 120, NFC chip 130, and automation device 110.

At the start of sequence 600, automation device 110 may be in a powered-off state. Mobile device 120 receives one or more configuration selections, as discussed above with respect to step 501 of process 500. These configuration selections may be input by a user of mobile device 120 and may include one or more of a selection of a device identification, a selection of an IP address, and one or more selections of operating parameters (as demonstrated, for example in user interface 700A of FIG. 7A). Mobile device 120 loads the configuration selections to NFC chip 130 via NFC link 140, as discussed above with respect to step 503 of FIG. 5. At some point after the configuration selections are loaded, automation device 110 is powered on, as represented by the dotted line in FIG. 6. During startup, automation device 110 retrieves the configuration selections and configures itself accordingly, as discussed above with respect to step 505 of process 500. Accordingly, a user may safely and efficiently set a configuration for automation device 110 while automation device 110 is in a powered-off state.

FIGS. 7A-7B illustrate user interfaces 700A, 700B of mobile device 120 according to some implementations. User interfaces 700A, 700B illustrate a sequence of interfaces displayed in a screen of mobile device 120 for a user performing device configuration tasks. User interfaces 700A, 700B are exemplary; in other implementations user interfaces on mobile device 120 for device configuration may have different arrangements (e.g., additional or fewer elements).

FIG. 7A illustrates user interface 700A in which a user enters configuration settings for automation device 110. Information element 750 provides information about automation device 110 that a user wishes to configure. User interface 700A further includes image 752 of automation device 110 (in this case, a PowerFlex 755TS). User interface 700A further includes “Set IP Address/Device Name” element 754 which a user may select to manually enter a device name and/or IP address into user interface 700A. User interface 700A further includes “Set Operating Parameters” element 756 which a user may select to manually enter operating parameters for automation device 110 (such as torque limits, speed settings, and various other operating parameters). Once the user has selected all desired parameters, the user may select “Load Configuration (NFC)” element 758 which a user may select to initiate the connection with NFC chip 130 and load the configuration selections.

FIG. 7B illustrates user interface 700B, in which a user is prompted to scan NFC chip 130 to load the configuration selections. User interface 700B may be displayed, for example, when the user has selected “Load Configuration” element 758 of FIG. 7A. User interface 700B includes an instruction element 760 which instructs the user to hold mobile device 120 close to NFC chip 130, and “Start scanning” element 762 which a user may tap to begin scanning. During the scan, the configuration selections (which may be represented by configurations 874 of FIG. 8) are transferred from mobile device 120 to NFC chip 130, as discussed in step 503 of FIG. 5.

FIG. 8 illustrates automation device 800 in an implementation. Automation device 800 may be automation device 110 of FIG. 1A or automation devices 110a, 110b, 110c of FIG. 1B. As illustrated, automation device 800 includes NFC chip 802 (noting that in alternative implementations, NFC chip 802 may be external to automation device 800, as demonstrated in FIG. 1B), power source 804, and user interface (I/F) system 806. NFC chip 802 is a component that enables short-range protocol connection capabilities for automation device 800. NFC chip 802 may be NFC chip 130 of FIGS. 1A and 1B. For example, NFC chip 802 may include or be connected to an antenna that allows the automation device 800 to establish NFC link 140 with mobile device 120. As will be described in greater detail below, NFC chip 802 may have power harvesting capabilities.

Power source 804 provides power to the automation device 800 when in a powered-on state. Power source 804 may be or include any variety of power sources, such as batteries, A/C power, D/C power, solar panels, and the like. User I/F system 806 may be or include a display or UI that allows a user to interact with the automation device 800, for example, by adjusting operating parameters of the automation device 800 (as described in FIGS. 5 and 6).

In some cases, the automation device 800 may include controller 808, one or more non-transitory computer-readable media 810, and software 812. Software 812 may be operating software that is stored in the non-transitory computer-readable media (CRM) 810 that, when executed by controller 808, causes automation device 800 to perform one or more functions. For example, an operating profile may be stored as instructions in non-transitory CRM 810 that, when executed by controller 808, causes automation device 800 to operate a piece of industrial equipment (e.g., conveyor belt, motor) according to the operating profile.

As noted above, automation device 800 may load fault codes 872 into NFC chip 802. Mobile device 120 may subsequently retrieve fault codes 872 from NFC chip 802 when automation device 800 is in a powered-off state. NFC chip 802 has power-harvesting capabilities, allowing it to draw power from the mobile device 120 during the NFC communication process to transfer the fault codes to the mobile device 120. Further, automation device 800 may receive a configuration, such as configuration 874, from the mobile device 120 when in a powered-off state. When the automation device 800 receives configuration 874 in a powered-off state, configuration 874 may be temporarily stored by the NFC chip 802. Since the NFC chip 802 has power harvesting capabilities, the NFC chip 802 is able to store and configuration 874 using the residual power harvested by the NFC chip 802. Once automation device 800 is powered on, configuration 874 is transferred to non-transitory CRM 810 for permanent storage. That is, once the automation device 800 is powered on, a current configuration that is stored in non-transitory CRM 810 is updated to configuration 874. In cases where automation device 800 receives configuration 874 in a powered-on state, then configuration 874 may be automatically updated and stored in non-transitory CRM 810.

FIG. 9 illustrates a computing system 901 that may be used for providing one or more functions of the maintenance processes described herein. For example, mobile device 120 may be or include the computing system 901. As illustrated, computing system 901 includes processing system 902 that includes a microprocessor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of the software 905 may be communicated internally or externally. Storage system 903 may be implemented as a single storage device but may also be implemented across multiple storage devices or sub-systems co-located or distributed relative to each other. Storage system 903 may comprise additional elements, such as a controller capable of communicating with processing system 902 or possibly other systems.

Software 905 (including software application 125) may be implemented in program instructions and among other functions may, when executed by processing system 902, direct processing system 902 to operate as described with respect to the various operational scenarios, sequences, and processes illustrated herein. For example, software 905 may include program instructions for providing the configuration process as described herein. For example, software 905 may include program instructions for providing one or more steps of processes 200 and 500.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing system 901 is representative) overall from a general-purpose computing system into a special-purpose computing system customized to support insights features, functionality, and user experiences. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112 (f) will begin with the words “means for”, but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

What is claimed is:

1. A method for device troubleshooting comprising:
identifying, by an automation device, an occurrence of a fault condition in the automation device,
loading, by the automation device, a fault code associated with the fault condition into non-volatile memory of a near field communication (NFC) chip; and
obtaining, at a software application on a mobile device, the fault code from the NFC chip when the automation device is in a powered-off state, wherein the obtaining is performed wirelessly via an NFC link.

2. The method of claim 1, further comprising:
receiving, at the software application of the mobile device, a request to view documentation associated with the fault code;
retrieving, by the software application of the mobile device, the documentation from a data repository; and
displaying, at the software application of the mobile device, the documentation in a user interface of the mobile device.

3. The method of claim 1, further comprising:
generating, at the software application of the mobile device, a prompt for an artificial intelligence model trained to provide recommendations for device troubleshooting, wherein the prompt comprises a request for a recommendation for addressing the fault condition;
receiving, at the software application of the mobile device, the recommendation from the artificial intelligence model; and
displaying, at the software application of the mobile device, the recommendation in a user interface of the mobile device.

4. The method of claim 1, further comprising:
loading, by the automation device, an identification of the automation device and an Internet Protocol (IP) address of the automation device into the non-volatile memory of the NFC chip; and
obtaining, at the software application, the identification and the IP address concurrently with obtaining the fault code.

5. The method of claim 1, further comprising:
receiving, at the software application, one or more configuration selections from a user via a user interface of the mobile device, and
loading, at the software application, the one or more configuration selections to the NFC chip via the NFC link, wherein the loading the selections is performed when the automation device is in the powered-off state; and
retrieving, by the automation device, the configuration selections from the NFC chip during startup of the automation device, and
configuring, by the automation device, the automation device according to the one or more configuration selections.

6. The method of claim 5, wherein the one or more configuration selections comprise one or more of:
an IP address selection,
a device identification selection, and
one or more operating parameter selections.

7. The method of claim 1, wherein the NFC chip is incorporated in the automation device.

8. The method of claim 1, wherein:
the automation device is one of a plurality of automation devices in a panel, and
the NFC chip is in communication with each of the plurality of automation devices to receive fault codes from each of the plurality of automation devices.

9. A device-troubleshooting system comprising:
an automation device, comprising one or more processors and one or more memories operably coupled to the one or more processors and having stored thereon first program instructions that, upon execution by the one or more processors, cause the one or more processors to:
identify an occurrence of a fault condition in the automation device,
load a fault code associated with the fault condition into non-volatile memory of a near field communication (NFC) chip; and
a software component comprising second program instructions executable by a mobile device to cause the mobile device to:
obtain the fault code from the non-volatile memory of the NFC chip, wherein the obtaining is performed when the automation device is in a powered-off state, and wherein the obtaining is performed wirelessly via an NFC link.

10. The system of claim 9, wherein the software component is further configured to:
receive, via a user interface of the mobile device, a request to view documentation associated with the fault code;
retrieve the documentation from a data repository; and
display the documentation in the user interface,

11. The system of claim 9, wherein the software component is further configured to:
generate a prompt for an artificial intelligence model trained to provide recommendations for device-troubleshooting, wherein the prompt comprises a request for a recommendation for addressing the fault condition;
receiving the recommendation from the artificial intelligence model; and
displaying the recommendation in a user interface of the mobile device.

12. The system of claim 9, wherein first program instruction comprise further program instructions that, upon execution by the one or more processors, cause the one or more processors to:
load an identification of the automation device and an Internet Protocol (IP) address of the automation device into the non-volatile memory of the NFC chip; and
wherein the second program instructions comprise further program instructions executable by the mobile device to:
obtain the identification and the IP address concurrently with the obtaining the fault code.

13. The system of claim 9, wherein the second program instructions comprise further instructions executable by the mobile device to:
receive one or more configuration selections from a user via a user interface of the mobile device, and
load the one or more configuration selections to the NFC chip via the NFC link, wherein the loading the configuration selections is performed when the automation device is in the powered-off state; and
wherein the first program instructions comprise further instructions that, upon execution by the one or more processors, cause the one or more processors to:
retrieve the configuration selections from the NFC chip during startup of the automation device, and
configure the automation device according to the one or more configuration selections.

14. The system of claim 13, wherein the one or more configuration selections comprise one or more of:
an IP address selection,
a device identification selection, and
one or more operating parameter selections.

15. The system of claim 14, wherein the NFC chip is incorporated in the automation device.

16. The system of claim 15, wherein:
the automation devices is one of a plurality of automation devices in a panel, and
the NFC chip is in communication with each of the plurality of automation devices to receive fault codes from each of the plurality of automation devices.

17. A computer-readable storage media device having program instructions stored thereon to facilitate device-shooting, wherein the program instructions, upon execution by one or more processors, cause the one or more processors to:
identify an occurrence of a fault condition in an automation device,
load a fault code associated with the fault condition into non-volatile memory of a near field communication (NFC) chip, such that the fault condition is retrievable by a mobile device from the NFC chip when the automation device is in a powered-off state.

18. The computer-readable storage media device of claim 17, wherein the program instructions comprise further instructions that, upon execution by the one or more processors, cause the one or more processors to:
retrieve, upon startup of the automation device, one or more configuration selections from the NFC chip, wherein the one or more configuration selections are loaded into the NFC chip from the mobile device; and
configure, by the automation device, the automation device according to the one or more configuration selections.

19. The computer-readable storage media device of claim 18, wherein the one or more configuration selections comprise one or more of:
an IP address selection,
a device identification selection, and
one or more operating parameter selections.

20. The computer-readable storage media device of claim 17, wherein the NFC chip is incorporated in the automation device.
